(19) United States
(12) Patent Application Publication
(10) Pub. No.: US 2022/0312882 A1
(43) Pub. Date: Oct. 6, 2022

(54) HELMET HAVING A BREATHING MASK ASSEMBLY

(71) Applicant: BOMBARDIER RECREATIONAL PRODUCTS INC., Valcourt (CA)

(72) Inventors: Michael ROY, Racine (CA); Alexandre LAPOINTE, Sherbrooke (CA)

(21) Appl. No.: 17/708,403

(22) Filed: Mar. 30, 2022

Related U.S. Application Data
(60) Provisional application No. 63/168,074, filed on Mar. 30, 2021.

(51) Int. Cl. A42B 3/28; A62B 18/08; A62B 18/10

(52) U.S. Cl. CPC A42B 3/288; A62B 18/084; A62B 18/10

(57) ABSTRACT

A helmet has a helmet shell, and a breathing mask assembly connected to the helmet shell. The breathing mask assembly has: a breathing mask; a flexible connector connecting the breathing mask to the helmet shell; and an actuator mounted to the breathing mask and operatively connected to the flexible connector. The actuator and the flexible connector are configured such that moving the actuator from a first position to a second position shortens a length of the flexible connector extending between the actuator and the helmet shell thereby moving the breathing mask closer to a rear of the helmet shell, the actuator moving with the breathing mask closer to the rear of the helmet shell.

### CROSS-REFERENCE

The present application claims priority to U.S. Provisional Patent Application No. 63/168,074, filed Mar. 30, 2021, the entirety of which is incorporated herein by reference.

### TECHNICAL FIELD

The present technology relates to a helmet having a breathing mask assembly.

### BACKGROUND

Full-face helmets have a helmet shell, a jaw shield, and a visor. The helmet shell protects the head of a wearer. The jaw shield protects the lower part of the face of the wearer, more particularly the jaw. The visor is mounted on the helmet shell and protects the eyes of the wearer.

At low temperature, water vapor in the humid air exhaled by the wearer can create condensation in the visor. This condensation can cause water and/or ice to form on the inside of the visor.

To avoid the problem of condensation, it is possible to open the visor to allow outside air to flow into the helmet until the condensation is eliminated. This, however, presents the problem that the wearer may be exposed to cold air, which can be uncomfortable to the wearer.

One solution consists in providing a breathing mask to capture the humid air exhaled by the wearer and exhaust it away from the visor. However, for the breathing mask to be effective and comfortable to the wearer it needs to be properly adjusted. As the problem of condensation typically occurs in cold weather, adjustment of the breathing mask should be possible even while wearing gloves or other hand coverings.

Therefore, there is a need for a helmet having a breathing mask where a position of the breathing mask can be adjusted.

### SUMMARY OF THE TECHNOLOGY

It is an object of the present technology to ameliorate at least some of the inconveniences present in the prior art.

According to one aspect of the present technology, there is provided a helmet having a helmet shell, and a breathing mask assembly connected to the helmet shell. The breathing mask assembly has: a breathing mask; a flexible connector connecting the breathing mask to the helmet shell; and an actuator mounted to the breathing mask and operatively connected to the flexible connector. The actuator and the flexible connector are configured such that moving the actuator from a first position to a second position shortens a length of the flexible connector extending between the actuator and the helmet shell thereby moving the breathing mask closer to a rear of the helmet shell, the actuator moving with the breathing mask closer to the rear of the helmet shell.

In some embodiments of the present technology, a right end of the flexible connector is connected to the helmet shell on a right side of the breathing mask; a left end of the flexible connector is connected to the helmet shell on a left side of the breathing mask; and the actuator is connected to a central portion of the flexible connector.

In some embodiments of the present technology, the actuator rotates between the first and second positions thereby winding the flexible cable about a portion of the actuator.

In some embodiments of the present technology, the actuator includes a turning knob.

In some embodiments of the present technology, the breathing mask assembly also has: a right mount connecting the breathing mask to a right side of the helmet shell; and a left mount connecting the breathing mask to a left side of the helmet shell. The right end of the flexible connector is connected to the right mount and the right mount connects the right end of the flexible connector to the right side of the helmet shell. The left end of the flexible connector is connected to the left mount and the left mount connects the left end of the flexible connector to the left side of the helmet shell.

In some embodiments of the present technology, the right mount removably connects the breathing mask to the right side of the helmet shell. The left mount removably connects the breathing mask to the left side of the helmet shell.

In some embodiments of the present technology, the breathing mask assembly also has: a right magnet connected to the right mount and removably connecting the right mount to the right side of the helmet shell; and a left magnet connected to the left mount and removably connecting the left mount to the left side of the helmet shell.

In some embodiments of the present technology, a right support is connected to the right side of the helmet shell. The right mount is connected to the right support. A left support is connected to the left side of the helmet shell. The left mount is connected to the left support.

In some embodiments of the present technology, the right mount defines a protrusion; the right support defines an aperture; the protrusion of the right mount is received in the aperture of the right support; the left mount defines a protrusion; the left support defines an aperture; and the protrusion of the left mount is received in the aperture of the left support.

In some embodiments of the present technology, the breathing mask assembly also has: a right conduit connected to the breathing mask and to the right mount, the right conduit defining a right air passage fluidly communicating with an interior of the breathing mask; and a left conduit connected to the breathing mask and to the left mount, the left conduit defining a left air passage fluidly communicating with the interior of the breathing mask.

In some embodiments of the present technology, the breathing mask defines a breathing mask air inlet, a right breathing mask air outlet and a left breathing mask air outlet. The breathing mask air inlet, the right breathing mask air outlet and the left breathing mask air outlet fluidly communicate with the interior of the breathing mask. The right mount defines a right mount air outlet. The left mount defines a left mount air outlet. The right conduit fluidly communicates the right breathing mask air outlet with the right mount air outlet. The left conduit fluidly communicates the left breathing mask air outlet with the left mount air outlet.

In some embodiments of the present technology, the breathing mask assembly also has: a one-way inlet valve connected to the breathing mask, the one-way inlet valve permitting air to flow into the interior of the breathing mask via the breathing mask air inlet and preventing air to flow out of the interior of the breathing mask via the breathing mask air inlet; a right one-way outlet valve connected to the breathing mask, the right one-way outlet valve permitting air to flow out of the interior of the breathing mask via the right breathing mask air outlet and preventing air to flow into the interior of the breathing mask via the right breathing mask air outlet; and a left one-way outlet valve connected to the breathing mask, the left one-way outlet valve permitting air to flow out of the interior of the breathing mask via the left breathing mask air outlet and preventing air to flow into the interior of the breathing mask via the left breathing mask air outlet.

In some embodiments of the present technology, the left and right conduits are flexible.

In some embodiments of the present technology, the breathing mask defines a breathing mask air inlet and at least one breathing mask air outlet. The breathing mask air inlet and the at least one breathing mask air outlet fluidly communicate with the interior of the breathing mask.

In some embodiments of the present technology, the breathing mask assembly also has: a one-way inlet valve connected to the breathing mask, the one-way inlet valve permitting air to flow into the interior of the breathing mask via the breathing mask air inlet and preventing air to flow out of the interior breathing mask via the breathing mask air inlet; and at least one one-way outlet valve connected to the breathing mask, the at least one one-way outlet valve permitting air to flow out of the interior of the breathing mask via the at least one breathing mask air outlet and preventing air to flow into the interior of the breathing mask via the at least one breathing mask air outlet.

In some embodiments of the present technology, a jaw shield is connected to the helmet shell. The breathing mask is disposed behind the jaw shield. The jaw shield defines a jaw shield air inlet. The jaw shield air inlet is aligned with the breathing mask air inlet.

In some embodiments of the present technology, a door is operatively connected to the jaw shield. The door is movable between a closed position closing the jaw shield air inlet and at least one open position at least partially opening the jaw shield air inlet.

In some embodiments of the present technology, the breathing mask air inlet is above the actuator.

In some embodiments of the present technology, a jaw shield is connected to the helmet shell. The breathing mask is disposed behind the jaw shield.

In some embodiments of the present technology, the jaw shield is movable between a lowered position and a raised position; in the lowered position, the breathing mask is disposed behind the jaw shield and the jaw shield covers the actuator; and in the raised position, the jaw shield is vertically higher than the breathing mask and the jaw shield does not cover the actuator.

In some embodiments of the present technology, the flexible connector is a cable.

In some embodiments of the present technology, a visor is connected to the helmet shell.

In some embodiments of the present technology, the visor is movable between a lowered position and a raised position.

In some embodiments of the present technology, an eye shield is connected to the helmet shell. The eye shield is movable between a lowered position and a raised position. In the lowered position of the eye shield and the lowered position of the visor: the eye shield is behind the visor; and the visor extends vertically lower than the eye shield.

According to another aspect of the present technology, there is provided a helmet having a helmet shell, a breathing mask assembly connected to the helmet shell, and a jaw shield connected to the helmet shell. The breathing mask assembly has: a breathing mask, and an adjustment assembly connected to the breathing mask. The adjustment assembly has an actuator. The adjustment assembly is configured such that moving the actuator from a first position to a second position moves the breathing mask closer to a rear of the helmet shell. The jaw shield is movable between a lowered position and a raised position. In the lowered position, the breathing mask is disposed behind the jaw shield and the jaw shield covers the actuator. In the raised position, the jaw shield is vertically higher than the breathing mask and the jaw shield does not cover the actuator.

In some embodiments of the present technology, the actuator rotates between the first and second positions.

In some embodiments of the present technology, the actuator includes a turning knob.

In some embodiments of the present technology, the breathing mask assembly also has: a right mount connecting the breathing mask to a right side of the helmet shell; and a left mount connecting the breathing mask to a left side of the helmet shell.

In some embodiments of the present technology, the right mount removably connects the breathing mask to the right side of the helmet shell, and the left mount removably connects the breathing mask to the left side of the helmet shell.

In some embodiments of the present technology, the breathing mask assembly also has: a right magnet connected to the right mount and removably connecting the right mount to the right side of the helmet shell; and a left magnet connected to the left mount and removably connecting the left mount to the left side of the helmet shell.

In some embodiments of the present technology, a right support is connected to the right side of the helmet shell, the right mount being connected to the right support. A left support is connected to the left side of the helmet shell, the left mount being connected to the left support.

In some embodiments of the present technology, the right mount defines a protrusion; the right support defines an aperture; the protrusion of the right mount is received in the aperture of the right support; the left mount defines a protrusion; the left support defines an aperture; and the protrusion of the left mount is received in the aperture of the left support.

In some embodiments of the present technology, the breathing mask assembly also has: a right conduit connected to the breathing mask and to the right mount, the right conduit defining a right air passage fluidly communicating with an interior of the breathing mask; and a left conduit connected to the breathing mask and to the left mount, the left conduit defining a left air passage fluidly communicating with the interior of the breathing mask.

In some embodiments of the present technology, the breathing mask defines a breathing mask air inlet, a right breathing mask air outlet and a left breathing mask air outlet. The breathing mask air inlet, the right breathing mask air outlet and the left breathing mask air outlet fluidly communicate with the interior of the breathing mask. The right mount defines a right mount air outlet. The left mount defines a left mount air outlet. The right conduit fluidly communicates the right breathing mask air outlet with the right mount air outlet. The left conduit fluidly communicates the left breathing mask air outlet with the left mount air outlet.

In some embodiments of the present technology, the breathing mask assembly also has: a one-way inlet valve connected to the breathing mask, the one-way inlet valve permitting air to flow into the interior of the breathing mask via the breathing mask air inlet and preventing air to flow out of the interior breathing mask via the breathing mask air inlet; a right one-way outlet valve connected to the breathing mask, the right one-way outlet valve permitting air to flow out of the interior of the breathing mask via the right breathing mask air outlet and preventing air to flow into the interior of the breathing mask via the right breathing mask air outlet; and a left one-way outlet valve connected to the breathing mask, the left one-way outlet valve permitting air to flow out of the interior of the breathing mask via the left breathing mask air outlet and preventing air to flow into the interior of the breathing mask via the left breathing mask air outlet.

In some embodiments of the present technology, the left and right conduits are flexible.

In some embodiments of the present technology, the breathing mask defines a breathing mask air inlet and at least one breathing mask air outlet. The breathing mask air inlet and the at least one breathing mask air outlet fluidly communicate with the interior of the breathing mask.

In some embodiments of the present technology, the breathing mask assembly also has: a one-way inlet valve connected to the breathing mask, the one-way inlet valve permitting air to flow into the interior of the breathing mask via the breathing mask air inlet and preventing air to flow out of the interior breathing mask via the breathing mask air inlet; and at least one one-way outlet valve connected to the breathing mask, the at least one one-way outlet valve permitting air to flow out of the interior of the breathing mask via the at least one breathing mask air outlet and preventing air to flow into the interior of the breathing mask via the at least one breathing mask air outlet.

In some embodiments of the present technology, the jaw shield defines a jaw shield air inlet. The jaw shield air inlet is aligned with the breathing mask air inlet.

In some embodiments of the present technology, a door is operatively connected to the jaw shield. The door is movable between a closed position closing the jaw shield air inlet and at least one open position at least partially opening the jaw shield air inlet.

In some embodiments of the present technology, the breathing mask air inlet is above the actuator.

In some embodiments of the present technology, a visor is connected to the helmet shell.

In some embodiments of the present technology, the visor is movable between a lowered position and a raised position.

In some embodiments of the present technology, an eye shield connected to the helmet shell. The eye shield is movable between a lowered position and a raised position. In the lowered position of the eye shield and the lowered position of the visor: the eye shield is behind the visor; and the visor extends vertically lower than the eye shield.

According to another aspect of the present technology, there is provided a method for adjusting a breathing mask of a helmet. The method comprises: moving a jaw shield relative to a helmet shell from a lowered position where the jaw shield covers an actuator to a raised position where the jaw shield does not cover the actuator, the actuator being operatively connected to the breathing mask; and after moving the jaw shield to the raised position, moving the actuator from a first position to a second position thereby moving the breathing mask closer to a rear of the helmet shell.

In some embodiments of the present technology, moving the actuator from the first position to the second position comprises rotating the actuator from the first position to the second position.

In some embodiments of the present technology, rotating the actuator from the first position to the second position winds a flexible connector connecting the breathing mask to the helmet shell.

In some embodiments of the present technology, rotating the actuator comprises turning a knob.

In some embodiments of the present technology, moving the jaw shield from the lowered position to the raised position comprises pivoting the jaw shield from the lowered position to the raised position.

For purposes of this application, terms related to spatial orientation such as left, right, front, rear, above, below, in front of, and behind are as they would normally be understood by a person wearing the helmet while standing in an upright position. Terms related to spatial orientation when describing or referring to components or assemblies of the helmet, separately from the helmet, such as a breathing mask assembly for example, should be understood as they would be understood when these components or assemblies are connected to the helmet.

Explanations and/or definitions of terms provided in the present application take precedence over explanations and/or definitions of these or similar terms that may be found in any documents incorporated herein by reference.

Additional and/or alternative objects, features, and advantages of the embodiments of the present invention will become apparent from the following description, the accompanying drawings, and the appended claims.

### BRIEF DESCRIPTION OF THE DRAWINGS

For a better understanding of the present invention as well as other objects and further features thereof, reference is made to the following description which is to be used in conjunction with the accompanying drawings, where:

FIG. 1 is a perspective view taken from a front, left side of a helmet, with a visor in a raised position and a jaw shield in a lowered position;

FIG. 2 is a left side elevation view of the helmet of FIG. 1, with the visor in a lowered position and the jaw shield in the lowered position;

FIG. 3 is a front elevation view of the helmet of FIG. 1, with the visor in the lowered position and the jaw shield in the lowered position;

FIG. 4 is a rear elevation view of the helmet of FIG. 1, with the visor in the lowered position and the jaw shield in the lowered position;

FIG. 5 is a left side elevation view of the helmet of FIG. 1, with the visor in the raised position and the jaw shield in a raised position;

FIG. 6 is a partially exploded perspective view, taken from a front, left side of a breathing mask assembly and corresponding supports of the helmet of FIG. 1;

FIG. 7 is another partially exploded perspective view, taken from a front, left side of the breathing mask assembly and corresponding supports of FIG. 6, with the breathing mask assembly being disconnected from the supports;

FIG. 8 is a top view of the breathing mask assembly and corresponding supports of FIG. 6;

FIG. 9 is a top view of the breathing mask assembly and corresponding supports of FIG. 6, with a breathing mask of the breathing mask assembly being adjusted at a position closer to a rear of a helmet shell of the helmet than in FIG. 8;

FIG. 10 is a perspective view taken from a top, rear side of the breathing mask assembly and corresponding supports of FIG. 6;

FIG. 11 is a perspective view taken from a top, rear side of the breathing mask assembly and corresponding supports of FIG. 6, with the breathing mask assembly being disconnected from the supports;

FIG. 12 is another partially exploded perspective view, taken from a front, right side of the breathing mask assembly and corresponding supports of FIG. 6;

FIG. 13A is a cross-section of the breathing mask assembly and corresponding supports of FIG. 6 taken through a plane normal to an axis of rotation of a knob of an adjustment assembly of the breathing mask assembly, the plane passing through the knob;

FIG. 13B is a close-up of a region of the breathing mask assembly of FIG. 13A containing the knob;

FIG. 14 is a cross-section of the breathing mask assembly and corresponding supports of FIG. 6 taken through a vertical plane containing the axis of rotation of the knob;

FIG. 15 is the cross-section of the breathing mask assembly and corresponding supports of FIG. 14, with the breathing mask assembly being disconnected from the supports;

FIG. 16 is a partially exploded perspective view, taken from a rear, left side of the breathing mask assembly and corresponding supports of FIG. 6, with a cable of the adjustment assembly being unwound; and

FIG. 17 is a partially exploded perspective view, taken from a rear, left side of the breathing mask assembly and corresponding supports of FIG. 6, with the cable of the adjustment assembly being wound.

### DETAILED DESCRIPTION

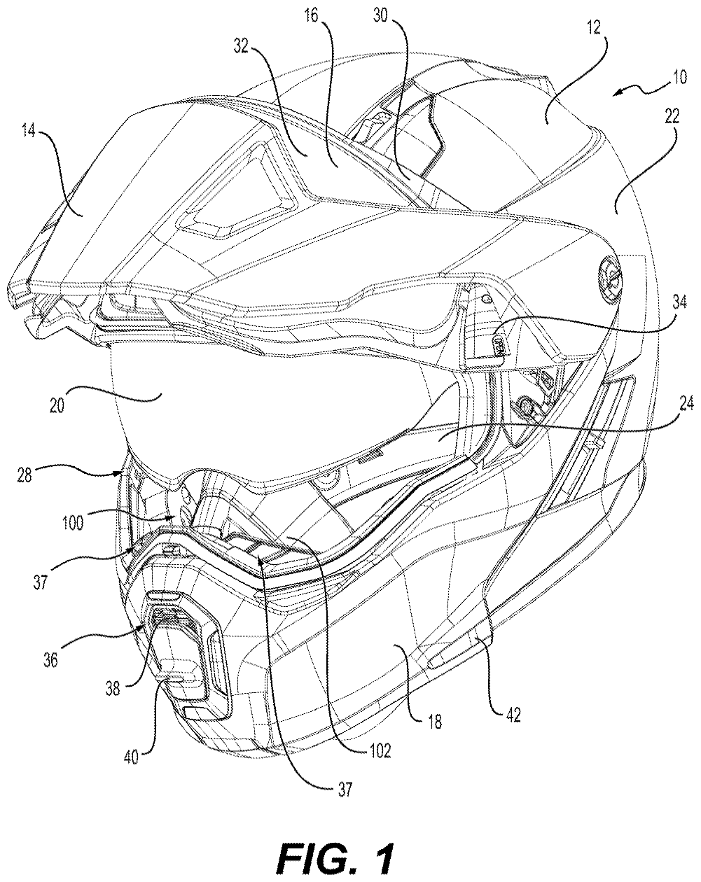

Turning now to FIGS. 1 to 5, a helmet 10 according to the present technology will be described. The helmet 10 is of a type commonly referred to as a “full-face helmet”, but it is contemplated that aspects of the present technology could be applied to other types of helmet. The helmet 10 has a helmet shell 12 that is adapted to protect a wearer's head. A peak 14 is pivotally connected to the sides of the helmet shell 12. The peak 14 extends forward of the helmet shell 12 to provide shade to the eyes of the wearer. A visor 16 is pivotally connected to the sides of the helmet shell 12. A jaw shield 18 is pivotally connected to the sides of the helmet shell 12. An eye shield 20 is pivotally connected to the helmet shell 12. It is contemplated that in some embodiments the eye shield 20 could be omitted. It is also contemplated that is some embodiments, the eye shield 20 could not pivot relative to the helmet shell 12. A chin strap (not shown) is connected to the helmet shell 12 to secure the helmet 10 under the chin of the wearer. The helmet 10 is also provided with a breathing mask assembly 100 connected to the helmet shell 12. The breathing mask assembly 100 will be described in more detail below.

As best seen in FIG. 1, the helmet shell 12 has an outer helmet shell 22, and an inner helmet shell 24. The inner helmet shell 24 is placed within the outer helmet shell 22. The outer helmet shell 22 is made of a rigid material, and the inner helmet shell 24 is made of a soft cushioning material, such as an expanded polystyrene (EPS) foam. It is contemplated that additional inner layers may be added to the helmet shell 12.

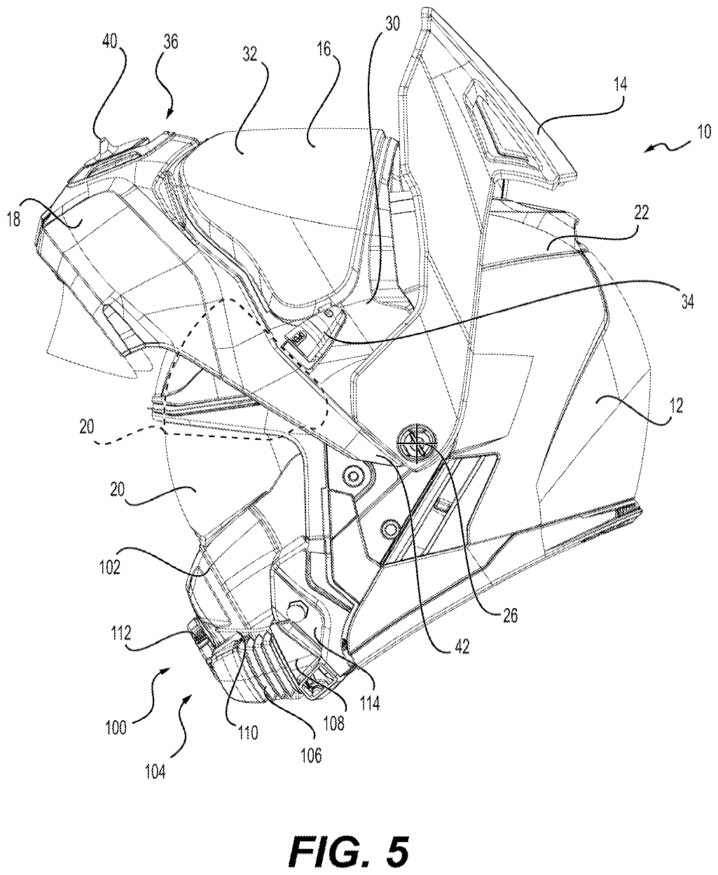

The peak 14 is pivotable relative to the helmet shell 12 about a pivot axis 26 between a lowered position, shown in FIGS. 1 to 4, and a raised position, shown in FIG. 5. The peak 14 is spaced from a top of the helmet shell 12 to allow pivoting of the visor 16 as will be described below. It is contemplated that in some embodiments the peak 14 could be omitted. It is also contemplated that is some embodiments, the peak 14 could not pivot relative to the helmet shell 12.

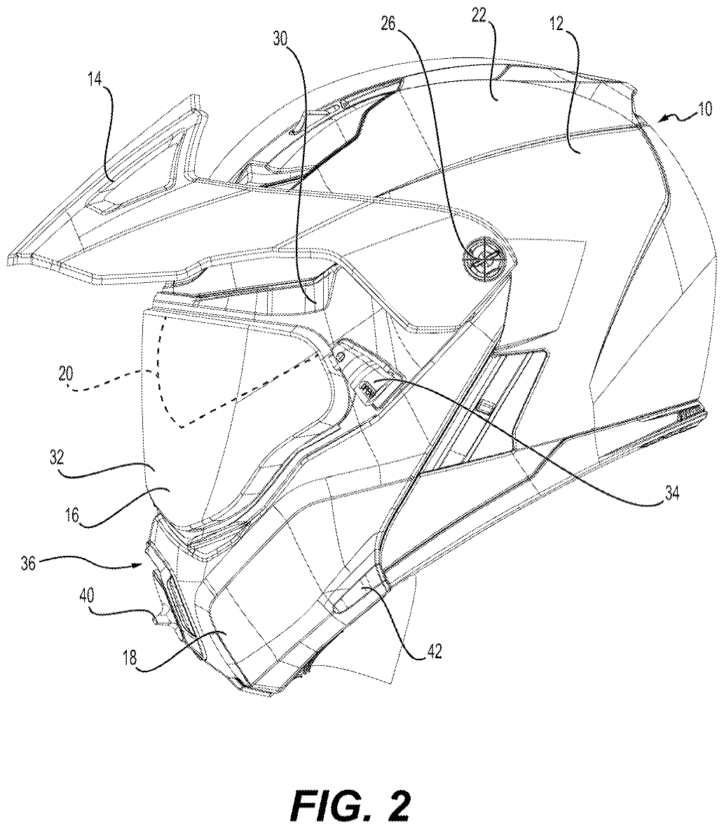

The visor 16 is pivotable relative to the helmet shell 12 about the pivot axis 26 between a lowered position, shown in FIGS. 2 to 4, and a raised position, shown in FIGS. 1 and 5. In the lowered position, the visor 16 closes an opening 28 (FIG. 1) defined in front of the wearer's eyes between an upper edge of the lowered jaw shield 18 and the front edge of the helmet shell 12. In the raised position, the visor 16 is out of the wearer's field of vision. The visor 16 can also be pivoted at positions intermediate the lowered and raised positions. As can be seen in FIG. 1, the visor 16 can be pivoted independently of the peak 14 and the jaw shield 18. When the visor 16 is pivoted to the raised position with the peak 14 being in its lowered position, the visor 16 is disposed between the peak 16 and the helmet shell 12 as can be seen in FIG. 1. It is contemplated that in some embodiments the visor 16 could be omitted. It is also contemplated that is some embodiments, the visor 16 could be fixed relative to the helmet shell 12 or could move relative to the helmet shell 12 in a manner other than by pivoting. It is also contemplated that in some embodiments, the visor 16 could be removable.

The visor 16 includes a frame 30 and a lens 32. The lens 32 is supported in the frame 30. It is contemplated that the lens 16 could be clear or tinted. In the present embodiment, a visor heating element (not shown) is applied to an inner side of the lens 32. The visor heating element is electrically powered. An electric connector 34 is mounted to the frame 30 and is electrically connected to the visor heating element. The electric connector 34 is configured to receive a plug of a power cord (not shown) that is connected to a power source, such as a battery or a vehicle's electric system. It is contemplated that the visor heating element and the electric connector 34 could be omitted. In an alternative embodiment, the visor heating element is electrically powered as described in U.S. Pat. No. 10,413,010 B2, issued Sep. 17, 2019, the entirety of which is incorporated herein by reference.

The jaw shield 18 is pivotable relative to the helmet shell 12 about the pivot axis 26 between a lowered position, shown in FIGS. 1 to 4, and a raised position, shown in FIG. 5. In the lowered position, the jaw shield 18 extends along a lower, front part of the helmet 10. In the raised position, the jaw shield 18 is out of the wearer's field of vision. The jaw shield 18 can also be pivoted at positions intermediate the lowered and raised positions. The peak 14 and the jaw shield 18 pivot together about the pivot axis 26, but it is contemplated that they could pivot independently from each other. The visor 16 can be pivoted to its raised positions independently of the peak 14 and the jaw shield 18. If the visor 16 is in its lowered positions, pivoting the peak 14 and the jaw shield 18 to their raised positions will also pivot the visor 16 to its raised position. If the peak 14, the visor 16 and the jaw shield 18 are in their raised positions, pivoting the visor 16 to its lowered position will also pivot the peak 14 and the jaw shield 18 to their lowered positions. If the peak 14, the visor 16 and the jaw shield 18 are in their raised positions, pivoting the peak 14 and the jaw shield 18 to their lowered positions will not pivot the visor 16 to its lowered position and the visor will remained in its raised position. It is contemplated that one or more of the peak 14, the visor 16 and the jaw shield 18 could pivot about an axis other than the pivot axis 26. It is contemplated that in some embodiments, the jaw shield 18 could be removably connected to the helmet shell 12. It is contemplated that in some embodiments the jaw shield 18 could be fixed relative to the helmet shell 12 or could move relative to the helmet shell 12 in a manner other than by pivoting. It is contemplated that in some embodiment, the jaw shield 18 could be integrally formed with the helmet shell 12. It is contemplated that in some embodiments the jaw shield 18 could be omitted.

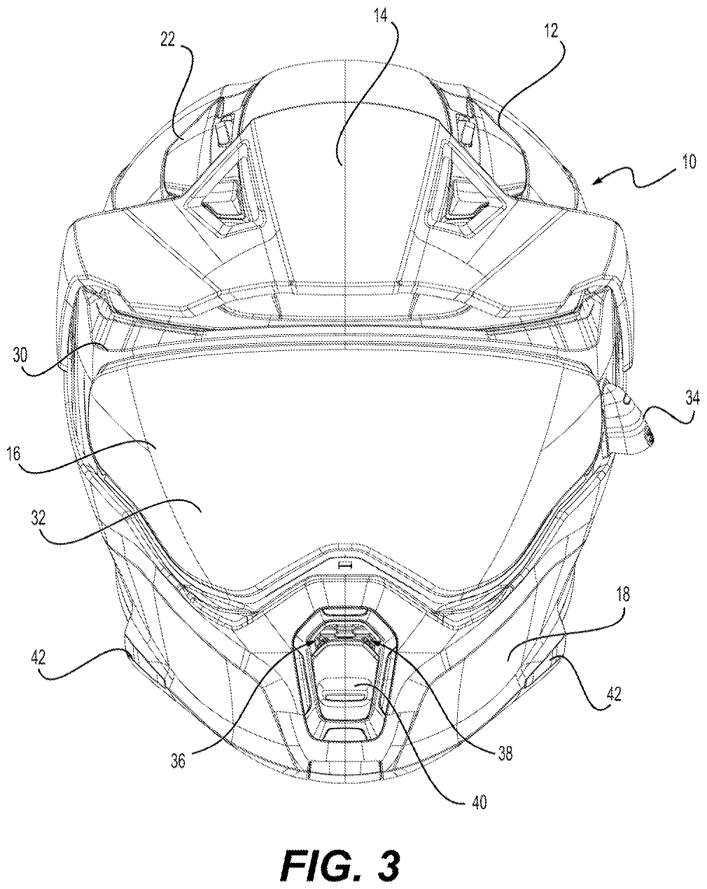

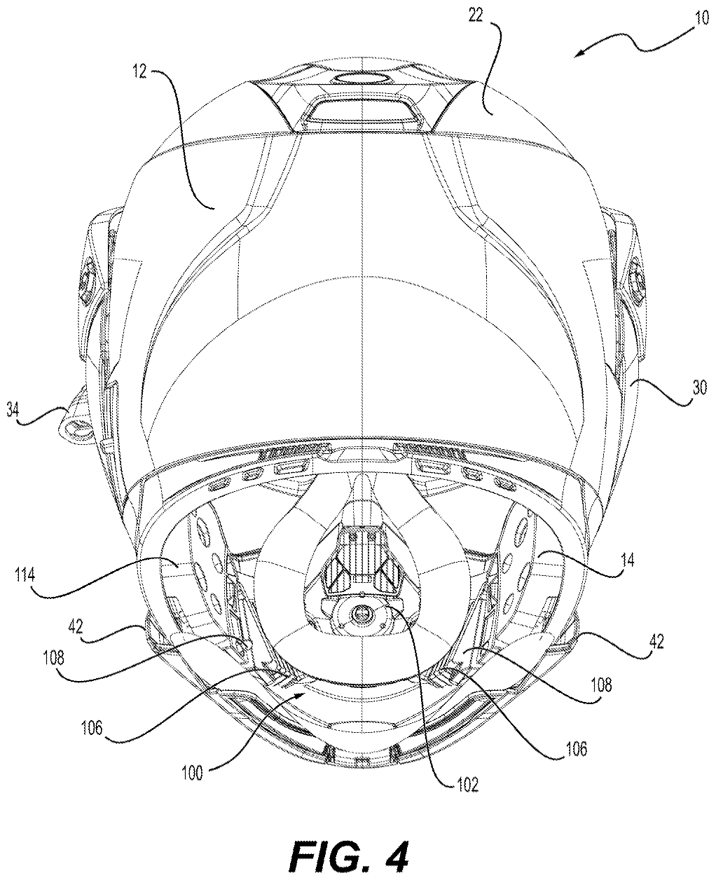

The jaw shield 18 defines a jaw shield air inlet 36 at a lateral center thereof. The jaw shield air inlet 36 fluidly communicates the atmosphere (i.e. the air around the outside of the helmet 10) with an interior of the helmet 10. More specifically, air entering the jaw shield air inlet 36 flows through air passages 37 (FIG. 1) connected to the jaw shield 18. These air passages 37 open into the interior of the helmet 10 and direct the air flowing therethrough upward over an inner surface of the lens 32 of the visor 16 (when the visor 16 is in the lowered position). A grill 38 is provided in the jaw shield air inlet 36. It is contemplated that the grill 38 could be omitted. A door 40 is operatively connected to the jaw shield 18. The door 40 slides vertically between an open position (shown in the figures) and a closed position (shown in dotted lines in FIG. 3). In the open position, the door 40 partially opens the jaw shield air inlet 36. It is contemplated that in the open position, the door 40 could completely open the jaw shield air inlet 36. In the closed position, the door 40 closes the jaw shield air inlet 36. The door 40 can also be moved at positions intermediate the open and closed positions. It is contemplated that the door 40 could alternatively slide laterally or pivot between the open and closed positions. It is also contemplated that the door 40 could be omitted. It is also contemplated that the jaw shield air inlet 36 could be omitted, in which case the grill 38 and the door 40 would also be omitted. As best seen in FIG. 4, the left and right side portions of the jaw shield 18 also define exhaust channels 42. The exhaust channels 42 receive air from the breathing mask assembly 100 to exhaust air from the breathing mask assembly 100 to the atmosphere as will be described in more detail below. As can be seen, the outlets of the exhaust channels 42 face generally toward a rear of the helmet 10, such that when the wearer of the helmet 10 is sitting on an open vehicle, such as a snowmobile or motorcycle, moving forward, a low pressure region is created behind the outlets of the exhaust channels 42 which assists in drawing air out of the breathing mask assembly 100 and the exhaust channels 42.

The eye shield 20 is movable relative to the helmet shell 12 between a lowered position, shown in FIGS. 1, 2 and 5, and a raised position, shown in dotted lines in FIG. 5. In the lowered position, the eye shied 20 is disposed in front of the wearer's eyes. In the raised position, the eye shield 20 is out of the wearer's field of vision and is received between the outer helmet shell 22 and the inner helmet shell 24. The eye shield 20 can also be pivoted at positions intermediate the lowered and raised positions. The eye shield 20 can be pivoted independently of the peak 14, the visor 16 and the jaw shield 18. As can be seen in FIG. 2, when the visor 16 and the eye shield 20 are in their lowered positions, the eye shield 20 is behind the visor 16, and the visor 16 extends vertically lower than the eye shield 20. It is contemplated that the eye shield 20 could be clear or tinted. It is contemplated that in some embodiments the eye shield 20 could be omitted. It is also contemplated that is some embodiments, the eye shield 20 could be fixed relative to the helmet shell 12 or could move relative to the helmet shell 12 in a manner other than by pivoting. It is also contemplated that in some embodiments, the eye shield could be removable.

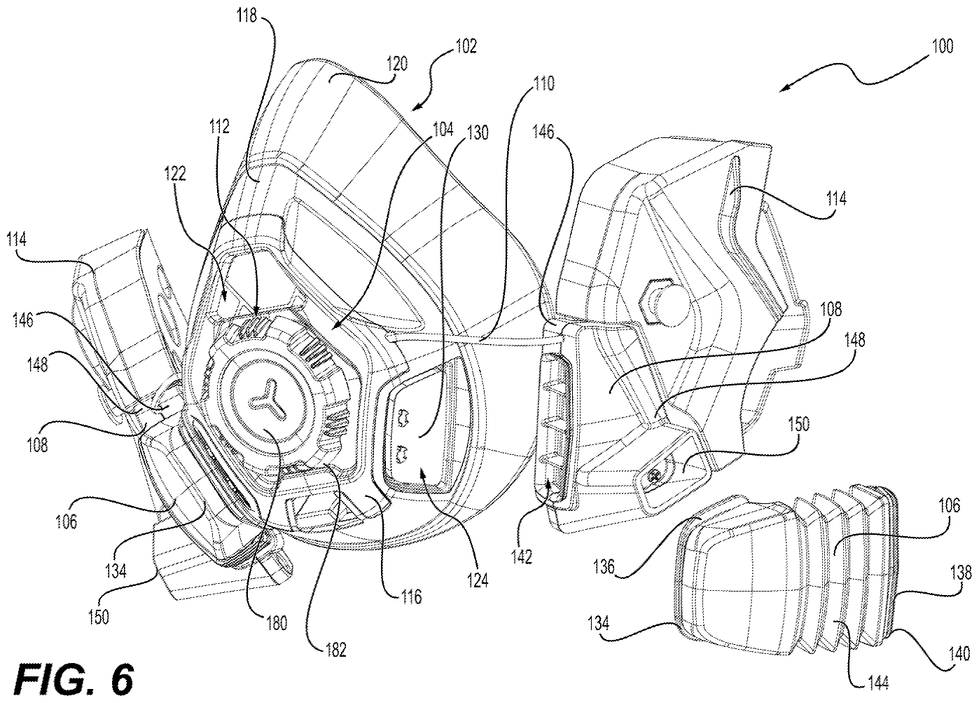

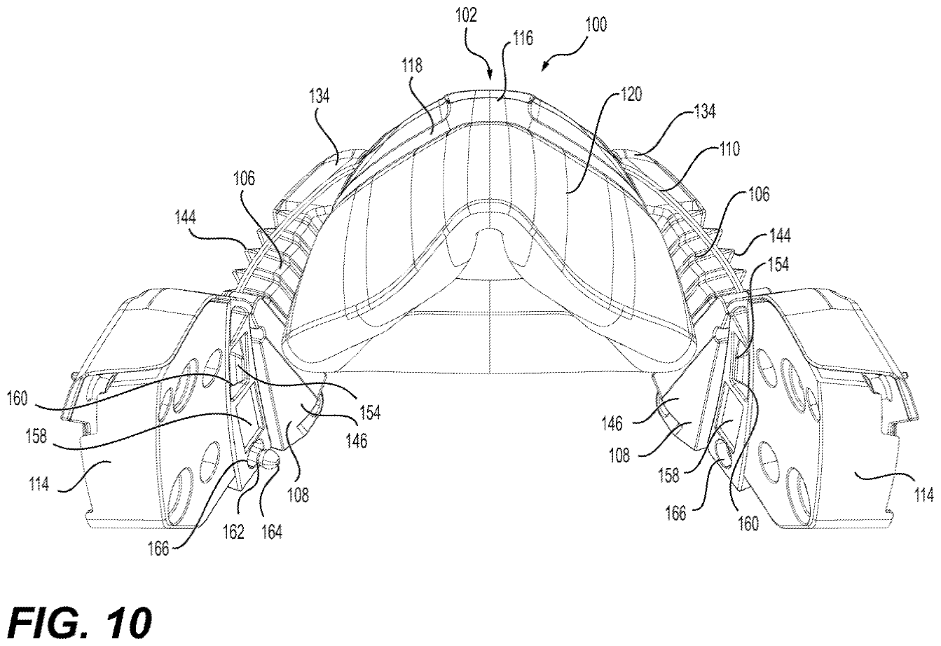

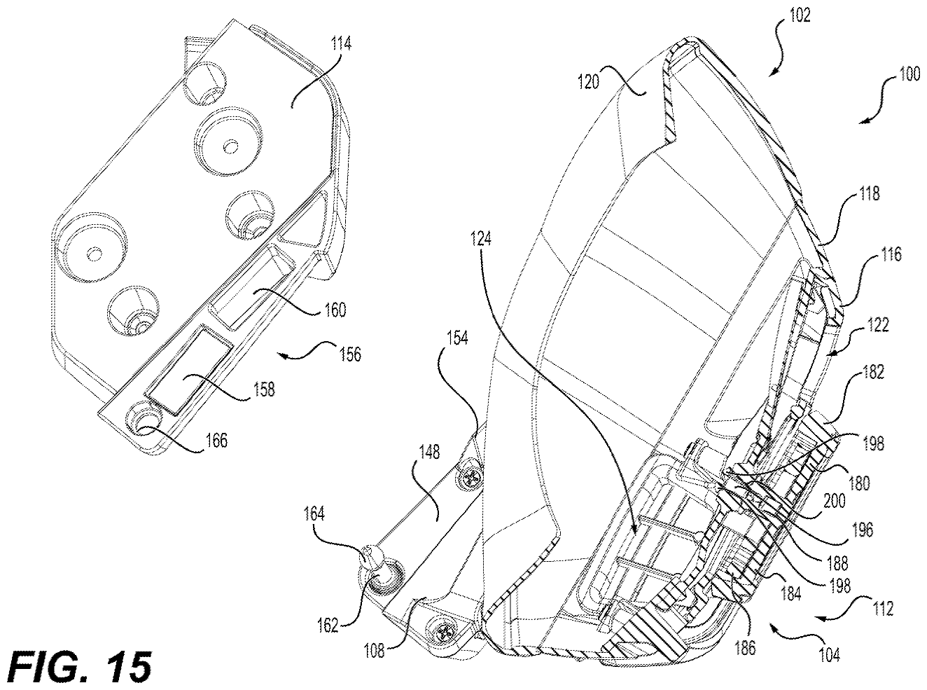

Turning now to FIGS. 6 to 17, the breathing mask assembly 100 will be described in more detail. The breathing mask assembly 100 has a breathing mask 102, an adjustment assembly 104, right and left conduits 106 connected to the breathing mask 102, and right and left mounts 108 connected to the right and left conduits 106 respectively. The adjustment assembly 104 has a flexible connector 110 and an actuator 112. The actuator 112 is mounted to the breathing mask 102 and is operatively connected to the flexible connector 110. Actuating the actuator 112 as will be described in more detail below causes the adjustment assembly 104 to move the breathing mask 102 closer or further from the wearer's face, and therefore closer or further from the rear of the helmet shell 12. As will be described in more detail below, the right and left mounts 108 connect the breathing mask assembly 100 to the helmet shell 12 via right and left supports 114 respectively. The right and left supports 114 are fastened to the right and left sides of the helmet shell 12, respectively, on the inside of the helmet shell 12. It is contemplated that in alternative embodiments, the supports 114 could be omitted and the breathing mask assembly 100 could be connected directly to the helmet shell 12. It is also contemplated that the breathing mask assembly 100 could be connected to the helmet shell 12 via the jaw shield 18.

As would be understood by comparing FIG. 1 to FIG. 5, in the lowered position of the jaw shield 18, the breathing mask 102 is disposed behind the jaw shield 18 and the jaw shield cover the actuator 112. As can be seen in FIG. 5, in the raised position of the jaw shield 18, the jaw shield 18 is vertically higher than the breathing mask 102 and the jaw shield 18 does not cover the actuator 112. As such, in order to adjust the position of the breathing mask 102, the wearer of the helmet 10 first needs to move the jaw shield 18 from the lowered position to the raised position to provide access to the actuator 112. The wearer of the helmet 10 can then actuate the actuator 112 of the adjustment assembly 104 to adjust the position of the breathing mask 102. Once the breathing mask 102 is adjusted to the wearer's satisfaction, the wearer of the helmet 10 can move the jaw shield 18 back to its lowered position.

With reference to FIGS. 6 and 12 to 16, the breathing mask 102 will be described in more detail. The breathing mask 102 has a mask frame including a front mask frame portion 116 and a rear mask frame portion 118 and a mask cushion 120. The mask cushion 120 is connected to the mask frame by having a front portion thereof stretched over the rear portion of the rear mask frame portion 118 and by having the front edge of the mask cushion 120 being engaged in a groove (not shown) defined in the rear mask frame portion 118. As can be seen, the mask cushion 120 is wide at the bottom in order to fit over the wearer's mouth and narrow at the top in order to fit over the wearer's nose. The mask cushion 120 is made of a flexible material, such as silicon for example, to comfortably conform to the wearer's facial features when the mask cushion is pressed against a face of the wearer.

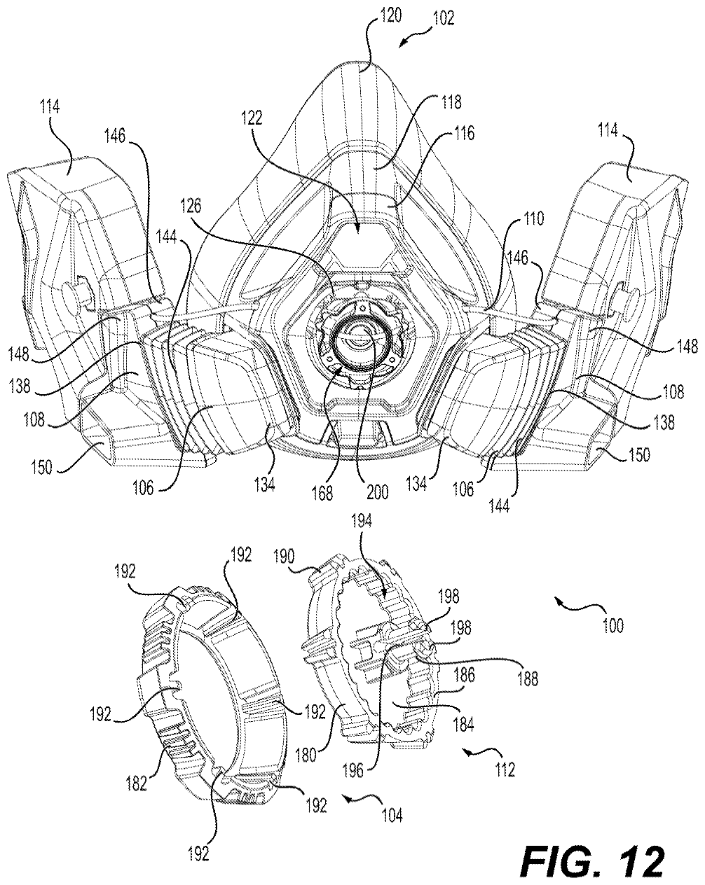

The front mask frame portion 116 defines a breathing mask air inlet 122 and the rear mask frame portion 118 defines right and left breathing mask air outlets 124. The breathing mask air inlet 122 and the breathing mask air outlet 124 fluidly communicate with an interior of the breathing mask 102. As can be seen, the breathing mask air inlet 122 is laterally centered on the front mask frame portion 116 near a top thereof. In the lowered position of the jaw shield 18, the jaw shield air inlet 36 is aligned with the breathing mask air inlet 122. The breathing mask air outlets 124 are disposed on the lower right and left portions of the rear mask portion 118. It is contemplated that the breathing mask 102 could have more than one breathing mask air inlet 122 and that the breathing mask air inlet could be disposed at a location other than the one shown herein. It is contemplated that the breathing mask 102 could have only one or more than two breathing mask air outlets 122 and that the breathing mask air outlets could be disposed at locations other than the ones shown herein. The front mask portion 116 also defines a laterally centered aperture 126 (FIG. 12) below the breathing mask air inlet 122. The aperture 126 receives a portion of the adjustment assembly 104 therein as will be described in more detail below.

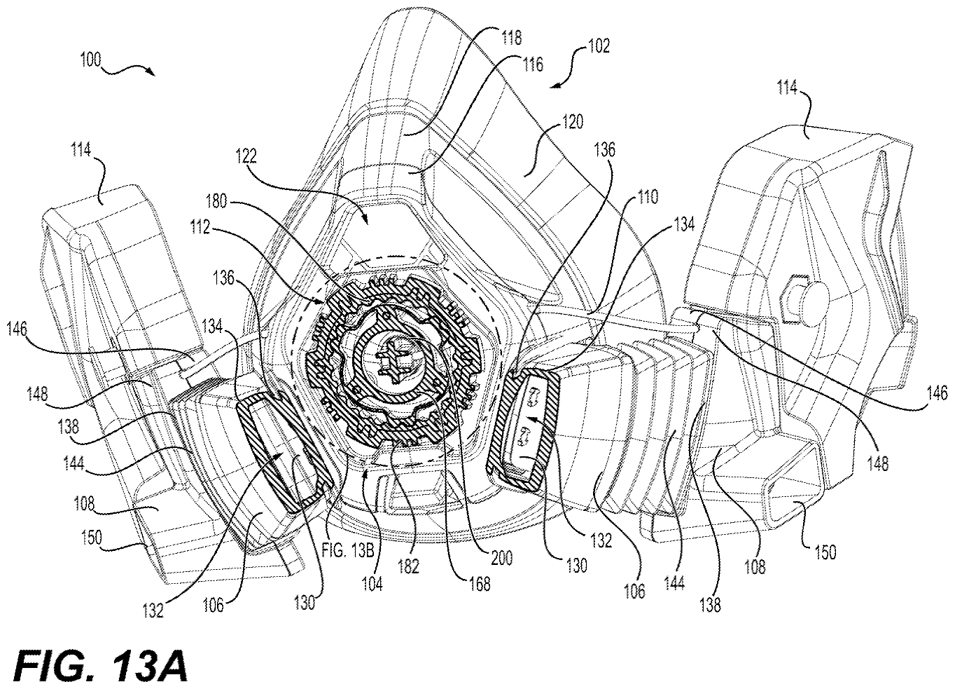

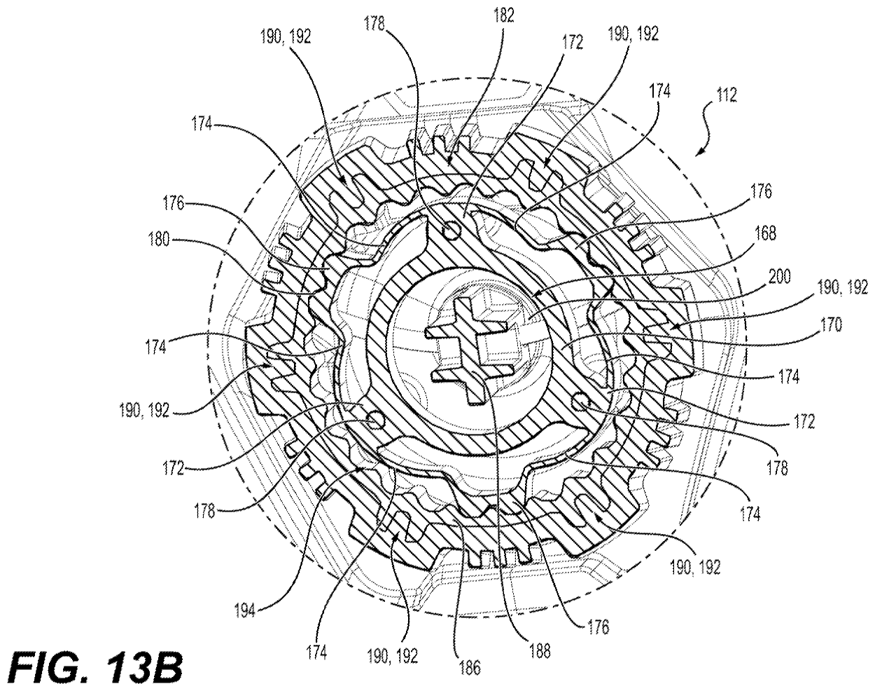

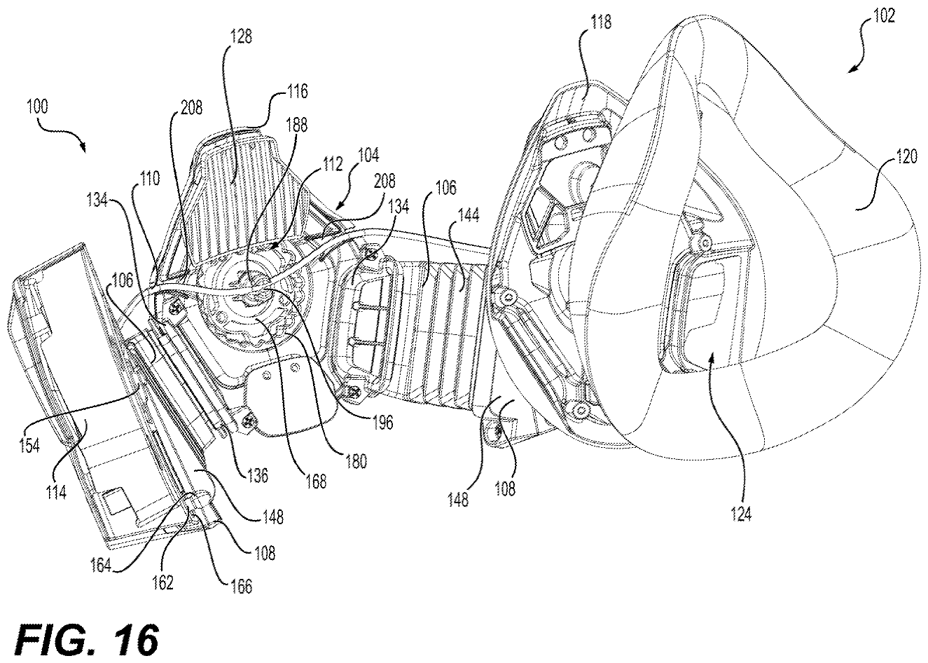

A one-way inlet valve 128 (FIG. 16) is connected to the front mask frame portion 116. The one-way inlet valve 128 is disposed behind the breathing mask air inlet 122. In the present embodiment, the one-way inlet valve 128 is a reed valve fastened at is top to the front mask frame portion 116. The one-way inlet valve 128 permits air to flow into the interior of the breathing mask 102 via the breathing mask air inlet 122 and prevents air to flow out of the interior of the breathing mask 102 via the breathing mask air inlet 122. A right one-way outlet valve 130 (FIG. 13A) is connected to the rear mask frame portion 118. The right one-way outlet valve 130 is disposed over of the right breathing mask air outlet 124. A left one-way outlet valve 130 (FIG. 6) is connected to the rear mask frame portion 118. The left one-way outlet valve 130 is disposed over the left breathing mask air outlet 124. The right and left one-way outlet valves 130 permit air to flow out of the interior of the breathing mask 102 via the right and left breathing mask air outlets 124 and prevent air to flow into the interior of the breathing mask 102 via the right and left breathing mask air outlets 124. In the present embodiment, the one-way outlet valves 130 are reed valves fastened at their fronts to the rear mask frame portion 118. It is contemplated that other types of valves could be used. It is also contemplated that in some embodiments one or more of the valves 128, 130.

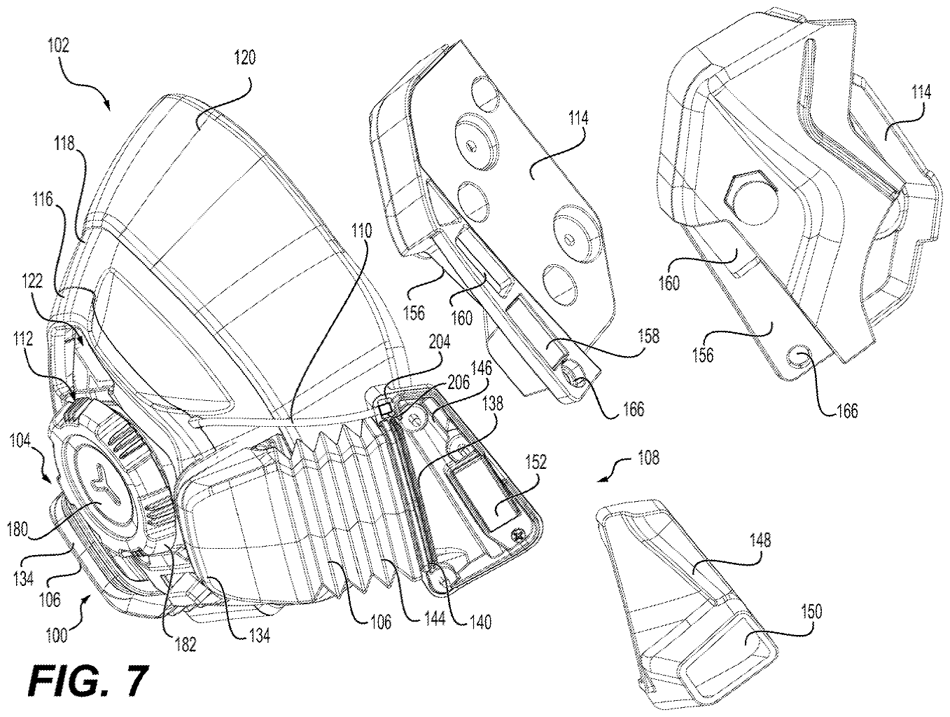

With reference to FIGS. 6, 7 and 13A, the conduits 106 will be described. The right and left conduits 106 define right and left air passages 132 (FIG. 13A) that fluidly communicate with the interior of the breathing mask 102 via the right and left breathing mask air outlets 124 respectively. The conduits 106 extend generally perpendicularly to the breathing mask air outlets 124 and extend generally rearward therefrom. The inlet end 134 of each conduit 106 defines a groove 136 (FIG. 13A). Each groove 136 receives the edge of the rear mask frame portion 118 defining the corresponding breathing mask air outlet 124, thereby connecting the inlet ends 134 of the conduits 106 to the breathing mask 102. The outlet end 138 of each conduit 106 defines a groove 140 (FIG. 7). Each groove 140 receives the edge of the mount 108 defining the corresponding mount air inlet 142 (the left one being shown in FIG. 6) of the right and left mounts 108 respectively. The conduits 106 are flexible and include an accordion-like portion 144 to allow the length of the conduits 106 to change as the position of the breathing mask 102 is adjusted.

As can be seen in FIG. 7 for the left mount 108, each mount 108 has an inner cover 146 and an outer cover 148. Each mount air inlet 142 is defined by the corresponding ones of the inner and outer cover 146, 148 at a front of the mounts 108. Right and left mount air outlets 150 are defined in a lower portion of the outer covers 148 of the right and left mounts 108. The mount air outlets 150 face generally laterally outward.

When the breathing mask assembly 100 is in use with the jaw shield 18 in the lowered position, air flows through the jaw shield air inlet 36 and the air passages 37 into the interior of the helmet 10. From the interior of the helmet 10, air then flows through the breathing mask air inlet 122 into the interior of the breathing mask 102. From the interior of the breathing mask 102, the air flows out of the breathing mask 102 via the breathing mask air outlets 124, through the air passages 132 of the conduits 106, and then through the mounts 108. The air then flows out of the mount air outlets 150 into the exhaust channels 42 of the jaw shield 18 to exhaust the air to the atmosphere.

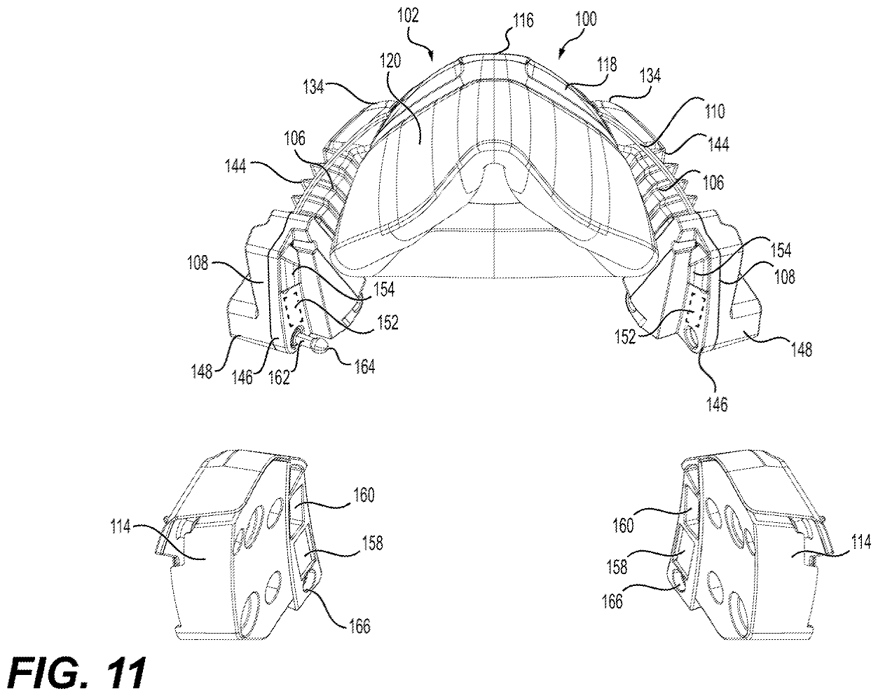

Right and left magnets 152 are connected to the right and left mounts 108 mounts respectively. More specifically, each magnet 152 is housed between the inner and outer covers 146 of its corresponding mount 108. As can be seen in FIG. 11, the inner covers 146 of the right and left mounts 108 each define a protrusion 154. The protrusions 154 are vertically higher than the magnets 152, extend generally laterally inward and are generally wedge-shaped. The right and left supports 114 each define a recess 156 to receive the right and left mounts 108 respectively. Each support 114 has a magnet 158 and defines an aperture 160 at a position vertically higher than the magnets 158. To removably connect the right mount 108 to the right support 114, and thereby to the right side of the helmet shell 12, the protrusion 154 of the right mount 108 is inserted in the aperture 160 of the right support 114. This aligns the right magnet 152 of the right mount 108 with the right magnet 158 of the right support 114, and the right mount 108 magnetically connects to the right support 114. Similarly, to removably connect the left mount 108 to the left support 114, and thereby to the left side of the helmet shell 12, the protrusion 154 of the left mount 108 is inserted in the aperture 160 of the left support 114. This aligns the left magnet 152 of the left mount 108 with the left magnet 158 of the left support 114, and the left mount 108 magnetically connects to the left support 114. As a result, the breathing mask assembly 100 is removably connected to the helmet shell 12. In addition to aligning the magnets 152 of the mounts 108 with the magnets 158 of the supports 114, the protrusions 154 prevent vertical and longitudinal movement of the mounts 108 when they are connected to the supports 114. It is contemplated that the magnets 152 or the magnets 158 could be replaced by a magnetic material. It is contemplated that the right and left mounts 108 could be removably connected to the right and left supports 114 by other means. It is also contemplated that in some embodiments, the breathing mask assembly 100 could be fixedly connected to the helmet shell 12.

As can be seen in FIG. 11, the inner cover 146 of the left mount 108 has a pin 162 extending inwardly. As can be seen, the pin 162 is vertically lower than the magnet 152. The pin 162 has a rounded head 164. The left support 114 has a corresponding aperture 166. The head 164 of the pin 162 is slightly larger than the aperture 166. When the left mount 108 is connected to the left support 114 as described above, the pin 162 is pressed through the aperture 166 at the same time. This provides a stronger connection than if no pin 162 was provided, as for the connection between the right mount 162 and the right support 114. The connection between the left mount 108 and the left support 114 via the pin 162 allows the wearer of the helmet 10 to disconnect the right mount 108 from the right support 114 and leave the breathing mask assembly 100 hanging from the left side of the helmet 10. The right support 114 also has an aperture 166, but this aperture 166 is not used in the present embodiment. It is contemplated that a pin 162 could alternatively or additionally extend from the inner cover 146 of the right mount 108. It is also contemplated that the pin 162 could be provided on the support 114 and that the aperture 166 could be provided in the mount 108. It is also contemplated that the pin 162 could be omitted.

With reference to FIGS. 12 to 17, the adjustment assembly 104 will now be described in more detail. As previously described, the adjustment assembly 104 has a flexible connector 110 and an actuator 112. The adjustment assembly 104 also has a round rack 168.

With reference to FIG. 13B, the rack 168 has a central annular portion 170. Three arms 172 extend radially outward from the central annular portion 170. Arcuate spring members 174 extend from the ends of the arms 172. A pair of rounded teeth 176 is connected between each pair of arcuate spring members 174. As a result, the rounded teeth 176 can be displaced radially inward toward the central annular portion 170, and the arcuate spring members 174 bias the rounded teeth 176 radially outward. As can be seen in FIG. 12, the rack 168 is received in the aperture 126 defined in the front mask frame portion 116. Three pins 178 (FIG. 13B) extend from the rear mask frame portion 118 and pass through the three arms 172 of the central annular portion 170 to connect the central annular portion 170 to the breathing mask 102 and to prevent the central annular portion 170 from rotating.

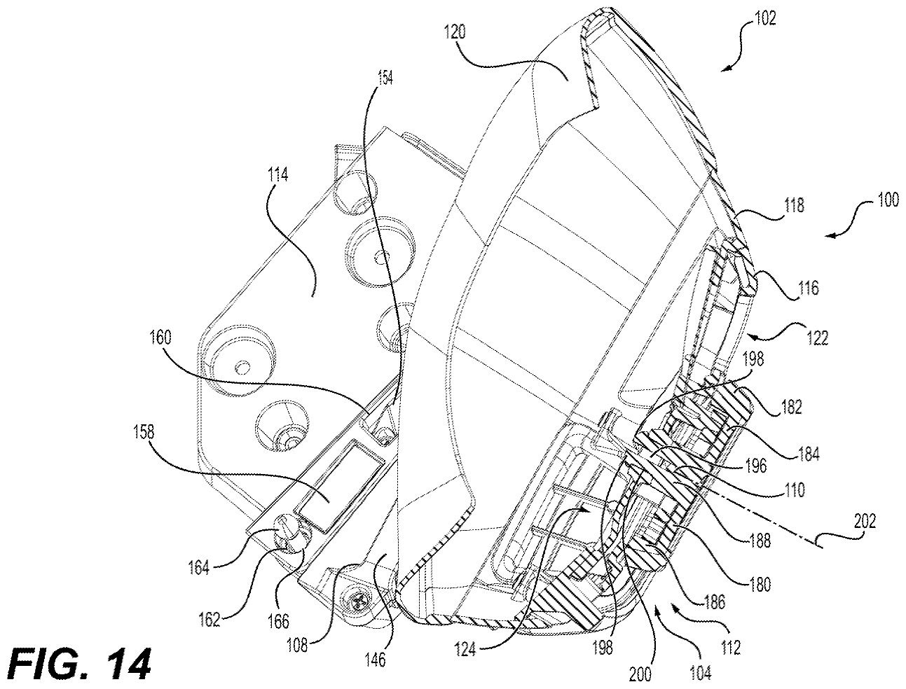

The actuator 112 includes a cap 180 and an annular knob 182. As can be seen in FIG. 6 for example, the breathing mask air inlet 122 is above the cap 180 and the knob 182. With reference to FIG. 12, the cap 180 has a generally circular front face 184, a rim 186 extending rearward from the front face 184 and a shaft 188 extending rearward from a center of the front face 184. The rim 186 has several teeth 190 extending radially outwardly therefrom. The knob 182 has a corresponding number of recesses 192 that mesh with the teeth 190 thereby connecting the knob 182 to the cap 180. As such, the knob 182 and the cap 180 are rotationally fixed relative to each other and turning the knob 182 turns the cap 180. The rim 186 of the cap 180 has a scalloped inner surface 194. The rounded recesses defined by the scalloped inner surface 194 have a shape corresponding to the shape of the teeth 176 of the rack 168 and engage the teeth 176 of the rack 168 as seen in FIG. 13B. The shaft 188 defines a slot 196 and has tabs 198 at the end thereof. The shaft 188 extends in the aperture 126 of the front mask frame portion 116, extends through the central annular portion 170 of the rack 168 and is inserted through an aperture 200 (FIG. 12) defined in the rear mask frame portion 118. As can be seen in FIG. 14, the shaft 188 clips in the rear mask frame portion 118 such that the tabs 198 of the shaft 188 retain the cap 180 and knob 182 on the rear mask frame portion 118. The cap 180 and knob 182 are thus rotationally connected to the rear mask frame portion 118 and can rotated together about a rotation axis 202 (FIG. 14). It is contemplated that the cap 180 and the knob 182 could be integrally formed.

When the knob 182 is turned, the teeth 176 of the rack 168 move radially thereby allowing rotation of the cap 180 and the knob 182. When the knob 182 stops turning, the arcuate spring members 174 push the teeth 176 radially outward such that the teeth 176 engage recesses of the scalloped inner surface 194 of the rim 186 of the cap 180, thereby holding the cap 180 and the knob 182 in position.

In the present embodiment, the flexible connector 110 is a cable 110. It is contemplated that other types of flexible connectors could be used, such as, but not limited to, a wire, a strap, a ribbon or a chain. The left end of the cable 110 is connected to the left mount 108 on a left side of the breathing mask 102. The left mount 108 connects the left end of the cable 110 to the left support 114, which connects it to the left side of the helmet shell 12. As can be seen in FIG. 7, the left end of the cable 110 is received in a cavity 204 defined between the inner and outer covers 146, 148 of the left mount 108. A ring 206 is fixed on the left end of the cable 110 and prevents the cable 110 from sliding out of the cavity 204. Alternatively, the ring 206 could be omitted and the left end of the cable 110 could be knotted and the knot could be received in the cavity 204. From its left end, the cable 110 extends forward and rightward above the left conduit 106 and enters the breathing mask 102 via a left passage 208 (FIG. 16) defined between the front and rear mask frame portions 116, 118. The central portion of the cable 110 then passes inside the slot 198 defined by the shaft 188 of the actuator 112. The central portion of the cable 110 is thus connected to the shaft 188 by being captured between the shaft 188 and the rear mask frame portion 118. From the shaft 188, the cable 110 exits the breathing mask 102 via a right passage 208 (FIG. 16) defined between the front and rear mask frame portions 116, 118 and extends rearward and rightward above the right conduit 106. The right end of the cable 110 is connected to the right mount 108 on a right side of the breathing mask 102. The right mount 108 connects the right end of the cable 110 to the right support 114, which connects it to the right side of the helmet shell 12. As for the left end of the cable 110, the right end of the cable 110 is received in a cavity 204 (not shown) defined between the inner and outer covers 146, 148 of the right mount 108. A ring 206 (not shown) is fixed on the right end of the cable 110 and prevents the cable 110 from sliding out of the cavity 204. Alternatively, the ring 206 could be omitted and the right end of the cable 110 could be knotted and the knot could be received in the cavity 204. In some embodiments, it is contemplated that the right and left ends of the cable 110 could be connected directly to the right and left supports 114 or directly to the right and left sides of the helmet shell 12. In some embodiments, it is contemplated that the cable 110 could extend inside the conduits 106.

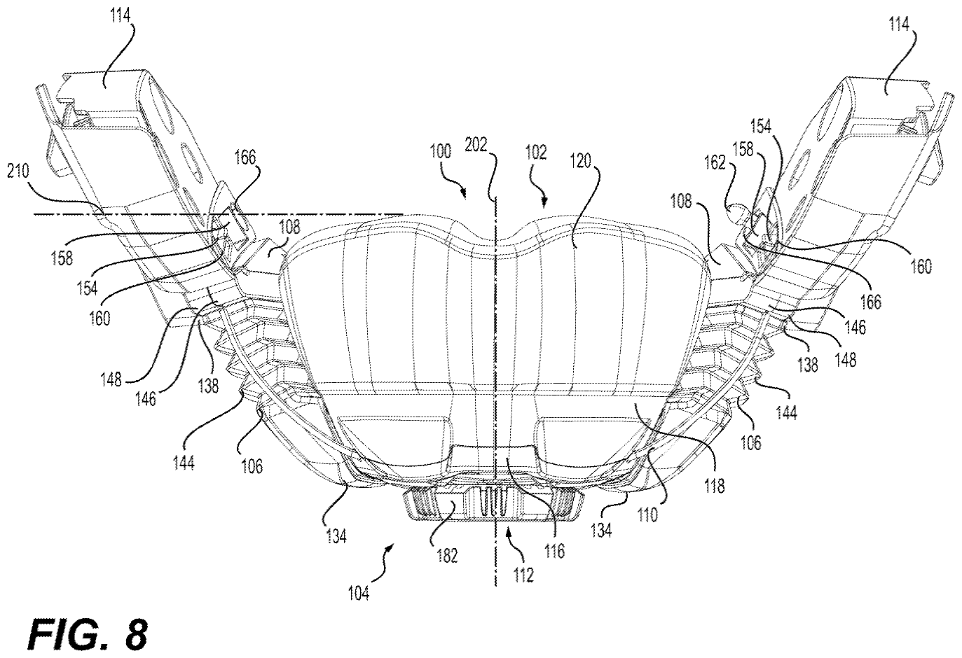

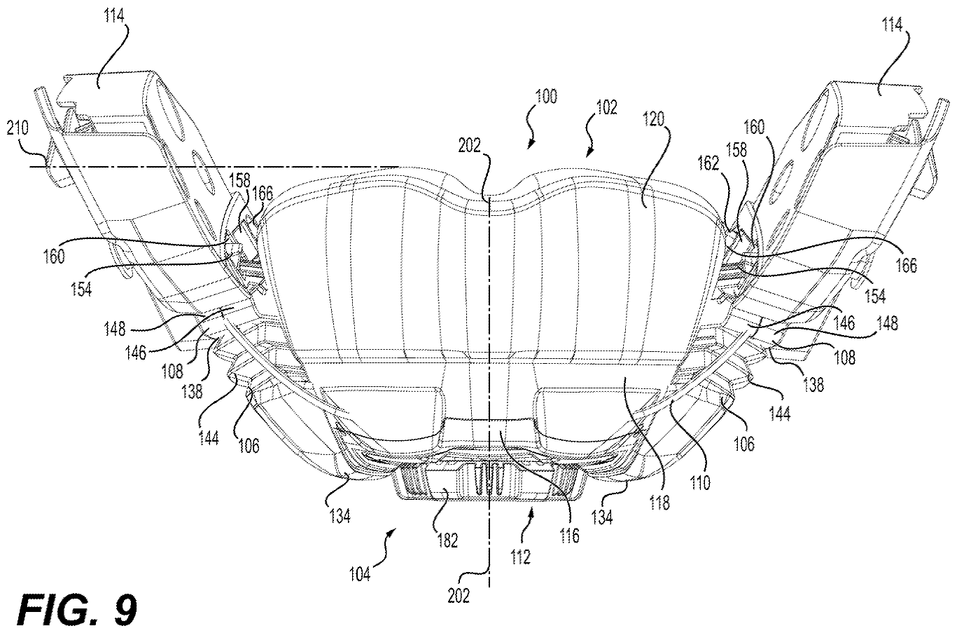

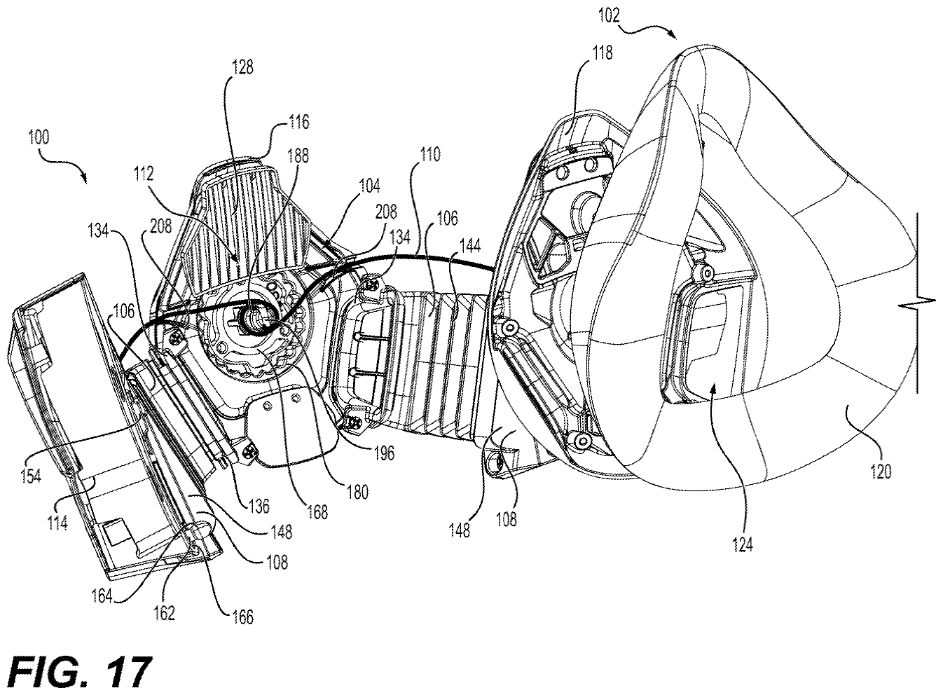

In order to adjust the breathing mask 102, after moving the jaw shield 18 from the lowered position to the raised position, the wearer of the helmet 10 rotates the actuator 112 (i.e. turns the knob 182). Turning the knob 182 winds or unwinds the central portion of the cable 110 about the shaft 188 which changes the position of the breathing mask 102. When the knob 182 is turned to wind the cable 110 about the shaft, by turning it from the position shown in FIG. 16 to the position shown in FIG. 17 for example, the length of the right and left portions of the cable 110 extending between the actuator 112, and more specifically the shaft 188, and their respective mounts 108 gets shorter. As a result, the actuator 112 and the breathing mask 102 move rearward, toward the rear of the helmet shell 12, and therefore toward the face of the wearer. This can be seen by comparing the position of a line 210 located at the rear edge of the breathing mask 102 relative the right support 114 in FIG. 8 to the position of the line 210 relative to the right support 114 in FIG. 9. In FIG. 8, the breathing mask 102 is at a position corresponding to the cable 110 not being wound about the shaft 188, as in FIG. 16. In FIG. 9, the breathing mask 102 is at a position corresponding to the cable 110 being wound about the shaft 188, as in FIG. 17. To move the actuator 112 and the breathing mask 102 forward, away from the rear of the helmet shell 12, and therefore away from the face of the wearer, the knob 182 is turned in the opposite direction. When the cable 110 is not wound about the shaft 188 as in FIG. 16, the knob 182 can be turned in either direction to wind the cable 110 about the shaft 110 and therefore move the actuator 112 and the breathing mask 102 rearward.

In an alternative embodiment, the cable 110 is replaced by right and left cables. The right cable has one end connected to the right mount 108 and one end connected to the shaft 188 and the left cable has one end connected to the left mount 108 and one end connected to the shaft 188. In this embodiment, turning the knob 182 winds and unwinds the right and left cables about the shaft and adjusts the position of the breathing mask 102 in a manner like the one described above.

In another alternative embodiment, a pinion is provided on the shaft 188. In such an embodiment, the cable 110 is replaced by two flexible strips each having a toothed edge. Each strip has one end connected to a corresponding one of the mounts 108 and has its toothed edge engage the pinion. One strip extends above the pinion, and the other strip extends below the pinion. Turning the knob 182 turns the pinion which causes the strips to translate. As a result, the length of the portions of the strips extending between the actuator and the mounts 108 changes, thereby moving the actuator and the breathing mask 102 forward or rearward relative to the rear of the helmet shell 12.

In yet another alternative embodiment, the cable 110 is replaced by two cables and the turning actuator 112 is replaced by an actuator having two sliders. Each cable has one end connected to a corresponding one of the mounts 108 and another end connected to a corresponding one of the sliders. By moving the sliders toward each other, the length of the portions of the cables extending between the actuator and the mounts 108 shortens, thereby moving the breathing mask 102 rearward toward the rear of the helmet shell 12.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

What is claimed is:

1. A helmet comprising:
a helmet shell; and
a breathing mask assembly connected to the helmet shell, the breathing mask assembly comprising:
a breathing mask;
a flexible connector connecting the breathing mask to the helmet shell; and
an actuator mounted to the breathing mask and operatively connected to the flexible connector,
the actuator and the flexible connector being configured such that moving the actuator from a first position to a second position shortens a length of the flexible connector extending between the actuator and the helmet shell thereby moving the breathing mask closer to a rear of the helmet shell, the actuator moving with the breathing mask closer to the rear of the helmet shell.

2. The helmet of claim 1, wherein:
a right end of the flexible connector is connected to the helmet shell on a right side of the breathing mask;
a left end of the flexible connector is connected to the helmet shell on a left side of the breathing mask; and
the actuator is connected to a central portion of the flexible connector.

3. The helmet of claim 2, wherein the actuator rotates between the first and second positions thereby winding the flexible cable about a portion of the actuator.

4. The helmet of claim 3, wherein the actuator includes a turning knob.

5. The helmet of claim 2, wherein:
the breathing mask assembly further comprises:
a right mount connecting the breathing mask to a right side of the helmet shell; and
a left mount connecting the breathing mask to a left side of the helmet shell;
the right end of the flexible connector is connected to the right mount and the right mount connects the right end of the flexible connector to the right side of the helmet shell; and
the left end of the flexible connector is connected to the left mount and the left mount connects the left end of the flexible connector to the left side of the helmet shell.

6. The helmet of claim 5, wherein:
the right mount removably connects the breathing mask to the right side of the helmet shell; and
the left mount removably connects the breathing mask to the left side of the helmet shell.

7. The helmet of claim 6, wherein the breathing mask assembly further comprises:
a right magnet connected to the right mount and removably connecting the right mount to the right side of the helmet shell; and
a left magnet connected to the left mount and removably connecting the left mount to the left side of the helmet shell.

8. The helmet of claim 5, further comprising:
a right support connected to the right side of the helmet shell, the right mount being connected to the right support; and
a left support connected to the left side of the helmet shell; the left mount being connected to the left support.

9. The helmet of claim 8, wherein:
the right mount defines a protrusion;
the right support defines an aperture;
the protrusion of the right mount is received in the aperture of the right support;
the left mount defines a protrusion;
the left support defines an aperture; and
the protrusion of the left mount is received in the aperture of the left support.

10. The helmet of claim 5, wherein the breathing mask assembly further comprises:
a right conduit connected to the breathing mask and to the right mount, the right conduit defining a right air passage fluidly communicating with an interior of the breathing mask; and
a left conduit connected to the breathing mask and to the left mount, the left conduit defining a left air passage fluidly communicating with the interior of the breathing mask.

11. The helmet of claim 10, wherein:
the breathing mask defines a breathing mask air inlet, a right breathing mask air outlet and a left breathing mask air outlet,
the breathing mask air inlet, the right breathing mask air outlet and the left breathing mask air outlet fluidly communicating with the interior of the breathing mask;
the right mount defines a right mount air outlet;
the left mount defines a left mount air outlet;
the right conduit fluidly communicates the right breathing mask air outlet with the right mount air outlet; and
the left conduit fluidly communicates the left breathing mask air outlet with the left mount air outlet.

12. The helmet of claim 11, wherein the breathing mask assembly further comprises:
a one-way inlet valve connected to the breathing mask, the one-way inlet valve permitting air to flow into the interior of the breathing mask via the breathing mask air inlet and preventing air to flow out of the interior of the breathing mask via the breathing mask air inlet;
a right one-way outlet valve connected to the breathing mask, the right one-way outlet valve permitting air to flow out of the interior of the breathing mask via the right breathing mask air outlet and preventing air to flow into the interior of the breathing mask via the right breathing mask air outlet; and
a left one-way outlet valve connected to the breathing mask, the left one-way outlet valve permitting air to flow out of the interior of the breathing mask via the left breathing mask air outlet and preventing air to flow into the interior of the breathing mask via the left breathing mask air outlet.

13. The helmet of claim 10, wherein the left and right conduits are flexible.

14. The helmet of claim 1, wherein:
the breathing mask defines a breathing mask air inlet and at least one breathing mask air outlet,
the breathing mask air inlet and the at least one breathing mask air outlet fluidly communicating with the interior of the breathing mask.

15. The helmet of claim 14, wherein the breathing mask assembly further comprises:
a one-way inlet valve connected to the breathing mask, the one-way inlet valve permitting air to flow into the interior of the breathing mask via the breathing mask air inlet and preventing air to flow out of the interior breathing mask via the breathing mask air inlet; and
at least one one-way outlet valve connected to the breathing mask, the at least one one-way outlet valve permitting air to flow out of the interior of the breathing mask via the at least one breathing mask air outlet and preventing air to flow into the interior of the breathing mask via the at least one breathing mask air outlet.

16. The helmet of claim 11, further comprising a jaw shield connected to the helmet shell; and
wherein:
the breathing mask is disposed behind the jaw shield;
the jaw shield defines a jaw shield air inlet; and
the jaw shield air inlet is aligned with the breathing mask air inlet.

17. The helmet of claim 16, further comprising a door operatively connected to the jaw shield, the door being movable between a closed position closing the jaw shield air inlet and at least one open position at least partially opening the jaw shield air inlet.

18. The helmet of claim 11, wherein the breathing mask air inlet is above the actuator.

19. The helmet of claim 1, further comprising a jaw shield connected to the helmet shell; and
wherein the breathing mask is disposed behind the jaw shield.

20. The helmet of claim 16, wherein:
the jaw shield is movable between a lowered position and a raised position;
in the lowered position, the breathing mask is disposed behind the jaw shield and the jaw shield covers the actuator; and
in the raised position, the jaw shield is vertically higher than the breathing mask and the jaw shield does not cover the actuator.
